(19) United States
(12) Patent Application Publication
(10) Pub. No.: US 2025/0053898 A1
(43) Pub. Date: Feb. 13, 2025

(54) MACHINE LEARNING PREDICTION OF PICKER ACCEPTING A NEW ORDER FOR FULFILLMENT BEFORE COMPLETING EXISTING BATCH OF ORDERS

(71) Applicant: Maplebear Inc., San Francisco, CA (US)

(72) Inventors: Kevin Charles Ryan, San Francisco, CA (US); Krishna Kumar Selvam, San Francisco, CA (US); Tahmid Shahriar, New York, NY (US); Sawyer Bowman, San Francisco, CA (US); Nicholas Rose, Toronto (CA); Ajay Pankaj Sampat, San Francisco, CA (US); Ziwei Shi, San Francisco, CA (US)

(21) Appl. No.: 18/233,252

(22) Filed: Aug. 11, 2023

(51) Int. Cl. G06Q 10/0631; G06Q 10/0833

(52) U.S. Cl. CPC G06Q 10/063116; G06Q 10/063114; G06Q 10/0833

(57) ABSTRACT

An online concierge system receives information describing the progress of a picker servicing a batch of existing orders and predicts a first likelihood the picker will finish servicing the batch within a threshold amount of time based on the picker's progress and information describing the batch. If the first likelihood exceeds a threshold likelihood, the system accesses a machine learning model trained to predict a second likelihood the picker will accept a batch of new orders for servicing while servicing the batch of existing orders. The system applies the model to inputs including a set of attributes of the picker and the picker's progress to predict the second likelihood. The system matches batches of new orders with pickers based on the second likelihood and sends one or more requests to service one or more batches matched with the picker to a client device associated with the picker.

### BACKGROUND

Online concierge systems allow customers to place online delivery orders and select delivery timeframes during which the orders are to be delivered. As orders are received, the orders may be assigned to sets of orders or “batches.” The batches are then typically matched with pickers who are not actively servicing batches based on various types of information (e.g., the pickers' location, preferences, etc. and delivery locations, delivery timeframes, etc. for orders included in the batches). Requests to service batches are then sent to pickers with which the batches are matched and the pickers may then accept the batches for servicing and perform various tasks involved in servicing orders included in the batches (e.g., driving to retailer locations, collecting items included in the orders, purchasing the items, and delivering the items to customers). Since batches that are quickly accepted and serviced are more likely to be delivered on time, it may be more efficient to match batches with pickers who are actively servicing batches than with pickers who are not since pickers who are actively servicing batches have already demonstrated an intent to service batches and may begin servicing additional batches as soon as they have finished their current batches.

However, the types of information often used to match batches with pickers may not take into account factors unique to pickers who are actively servicing batches, which may have adverse consequences. For example, even though pickers who are actively servicing batches and have already worked the maximum number of hours they would like to work for the day are unlikely to accept additional batches for servicing, they may still be matched with additional batches, which may decrease the rate at which batches are accepted for servicing. As an additional example, requests to service batches sent to pickers who are actively servicing batches may negatively affect picker performance and customer satisfaction if the pickers collect the wrong items or fail to follow instructions for collecting items because they are distracted by the requests. As yet another example, picker experience may be negatively affected if pickers servicing batches become overwhelmed with requests to service additional batches when they are already busy with their current batches (e.g., driving out of congested parking lots).

### SUMMARY

In accordance with one or more aspects of the disclosure, an online concierge system predicts a likelihood that a picker servicing a batch of existing orders placed with the online concierge system will accept a batch of new orders for servicing. More specifically, an online concierge system receives information describing the progress of a picker servicing a batch of existing orders and predicts a first likelihood that the picker will finish servicing the batch of existing orders within a threshold amount of time based on the progress of the picker and information describing the batch of existing orders. The online concierge system then determines whether the first likelihood exceeds a threshold likelihood. Responsive to determining the first likelihood exceeds the threshold likelihood, the online concierge system accesses a machine learning model trained to predict a second likelihood that the picker will accept a batch of new orders for servicing while servicing the batch of existing orders. The online concierge system applies the machine learning model to a set of inputs to predict the second likelihood, in which the set of inputs includes a set of attributes of the picker and the progress of the picker. The online concierge system then matches multiple batches of new orders with multiple pickers based on the second likelihood. The online concierge system determines whether one or more batches of new orders are matched with the picker and sends one or more requests to service the batches to a client device associated with the picker responsive to determining the batches are matched with the picker.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart of a method for predicting a likelihood that a picker servicing a batch of existing orders placed with an online concierge system will accept a batch of new orders for servicing, in accordance with one or more embodiments.

FIG. 4 illustrates an example of information describing the progress of a picker servicing a batch of existing orders, in accordance with one or more embodiments.

FIG. 5 illustrates an example of matching a batch of new orders with one or more pickers, in accordance with one or more embodiments.

FIG. 6 illustrates an example of a request to service a batch of new orders sent to a picker client device associated with a picker servicing a batch of existing orders, in accordance with one or more embodiments.

### DETAILED DESCRIPTION

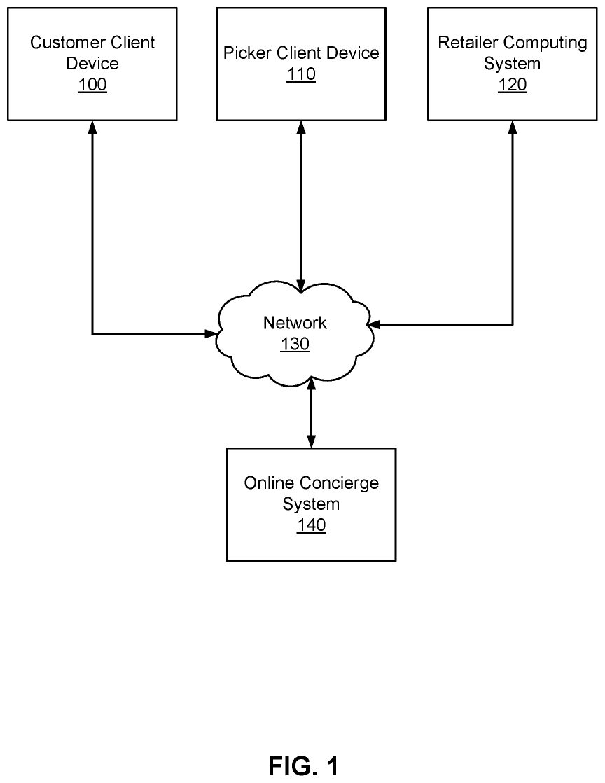

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or a desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, refers to a good or product that may be provided to the customer through the online concierge system 140. The order may include item identifiers (e.g., a stock keeping unit or a price look-up code) for items to be delivered to the customer and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the customer has selected for an order but that has not yet been finalized for an order. The ordering interface allows a customer to update the shopping list, e.g., by changing the quantity of items, adding or removing items, or adding instructions for items that specify how the items should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the customer to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer location. The picker client device 110 presents the items that are included in the customer's order to the picker in a collection interface. The collection interface is a user interface that provides information to the picker identifying items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 provides instructions to a picker for delivering the items for a customer's order. For example, the picker client device 110 displays a delivery location from the order to the picker. The picker client device 110 also provides navigation instructions for the picker to travel from the retailer location to the delivery location. If a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140. Additionally, while the description herein may primarily refer to pickers as humans, in some embodiments, some or all of the steps taken by the picker may be automated. For example, a semi-or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 may provide item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a customer's order (e.g., as a commission).

The customer client device 100, the picker client device 110, the retailer computing system 120, and the online concierge system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

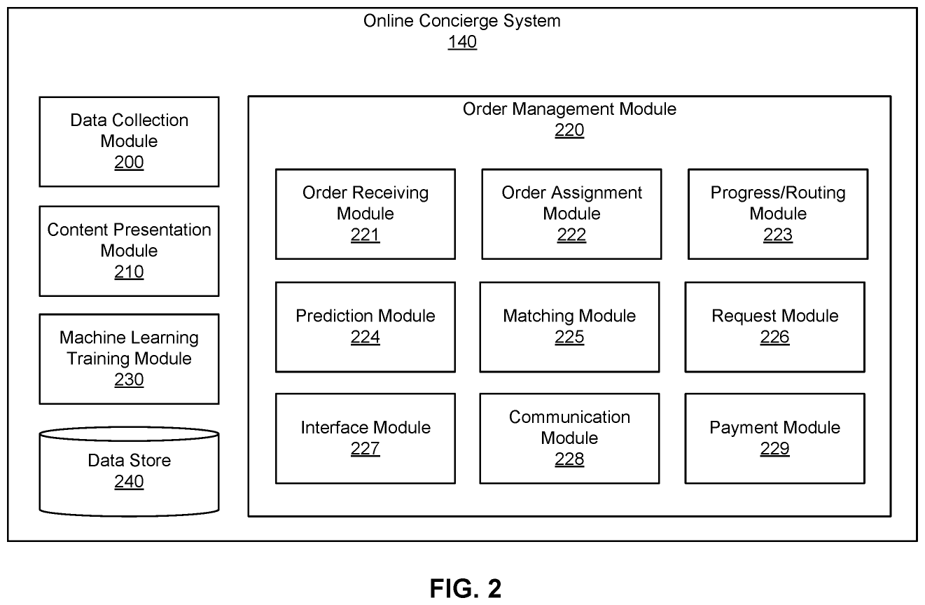

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer. As an example, the online concierge system 140 may allow a customer to order groceries from a grocery store retailer. The customer's order may specify which groceries they want delivered from the grocery store and the quantities of each of the groceries. The customer client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

The data collection module 200 collects customer data, which is information or data describing characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the sizes, colors, weights, stock keeping units (SKUs), or serial numbers for the items. The item data may further include purchasing rules associated with each item, if they exist. For example, age-restricted items such as alcohol and tobacco are flagged accordingly in the item data. Item data may also include information that is useful for predicting the availability of items at retailer locations. For example, for each item-retailer combination (a particular item at a particular retailer location), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or a customer client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data describing characteristics of pickers. For example, the picker data for a picker may include the picker's name, the picker's location, how often the picker has serviced orders for the online concierge system 140, a customer rating for the picker, the retailers from which the picker has collected items, or the picker's previous shopping history. In the above example, the picker's previous shopping history may describe a timespan during which the picker serviced each order and information describing each order serviced by the picker (e.g., an order number for the order, a number of items included in the order, a retailer location from which the items were collected, a payment amount for servicing the order, etc.). As an additional example, the picker data for a picker may include the picker's progress while servicing each order, such as a time or a timespan during which the picker performed each task involved in servicing the order (e.g., collecting each item in the order, driving to a retailer location or a delivery location for the order, checking out, delivering the order, etc.). As yet another example, the picker data for a picker may include historical data describing requests to service batches of new orders sent to a picker client device 110 associated with the picker, a location associated with the picker at the time each request was sent, the picker's response to each request, and information describing each order associated with each request (e.g., a payment amount, a number of items included in the order, etc.). Additionally, the picker data may include preferences expressed by the picker, such as their preferred retailers for collecting items, how far they are willing to travel to deliver items to a customer, how many items they are willing to collect at a time, timeframes within which the picker is willing to service orders, or payment information by which the picker is to be paid for servicing orders (e.g., a bank account).

In some embodiments, picker data also may include information associated with a picker that the data collection module 200 may determine based on other picker data for the picker. Examples of such types of information include: an average rate at which the picker collects items, an average number of hours the picker services orders (e.g., per day, on a given day of the week, etc.), an average amount of earnings for the picker (e.g., per day, on a given day of the week, etc.), an average amount of time that the picker takes to accept a batch of new orders for servicing (e.g., while servicing a batch of existing orders), etc. As noted above, the data collection module 200 may only collect data describing a user if the user has previously explicitly consented to the online concierge system 140 collecting data describing the user. For example, the data collection module 200 may only collect information describing an average number of hours a picker services orders per day or on a given day of the week and an average amount of earnings for the picker per day or on a given day of the week if the picker opted in to allow the online concierge system 140 to collect such information. The data collection module 200 collects picker data from sensors of the picker client device 110 or from the picker's interactions with the online concierge system 140.

Additionally, the data collection module 200 collects order data, which is information or data describing characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The data collection module 200 also collects marketplace data, which is information or data describing a state of a marketplace at a particular time. For example, marketplace data for a particular time may describe the time of day and orders placed with the online concierge system 140 (e.g., a number of orders, a geographic region associated with the orders, retailers associated with the orders, a number of items included in each order, etc.). In the above example, marketplace data also may describe a busyness associated with one or more retailer locations from which items included in the orders were collected (e.g., an amount of congestion associated with checking out or a parking lot at each retailer location) or any other suitable types of information. The data collection module 200 may collect marketplace data from one or more picker client devices 110, one or more retailer computing systems 120, the prediction module 224 (described below), or any other suitable source.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. In this example, the content presentation module 210 then displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 manages orders for items from customers. Components of the order management module 220 include: an order receiving module 221, an order assignment module 222, a progress/routing module 223, a prediction module 224, a matching module 225, a request module 226, an interface module 227, a communication module 228, and a payment module 229, which are further described below.

The order receiving module 221 receives information describing new orders from customer client devices 100. The order receiving module 221 may receive various types of information describing each new order received from a customer client device 100. For example, the order receiving module 221 may receive information describing a retailer location from which one or more items included in a new order are to be collected (e.g., a name and an address of the retailer location), the item(s) to be collected (e.g., a name, a brand, a quantity, a weight, a volume, etc. of each item), and instructions for collecting the item(s). As an additional example, the order receiving module 221 may receive information including a payment amount associated with servicing a new order (e.g., a payrate, a tip amount, etc.), information describing a delivery location (e.g., a delivery address, whether the delivery location is a residence or a business or includes stairs, etc.), delivery instructions, and a delivery timeframe for the new order.

The order assignment module 222 assigns one or more new orders received by the order receiving module 221 to a set or “batch” of orders to be serviced together as a single job. The order assignment module 222 may assign the new order(s) to a batch based on various types of information associated with each new order. Examples of such types of information include: a retailer location from which one or more items included in each new order are to be collected, a number of items included in each new order, a size of each item included in each new order, a type of each item included in each new order, a delivery location for each new order, a delivery timeframe for each new order, or any other suitable types of information. For example, the order assignment module 222 may assign multiple new orders to the same batch if items included in the new orders are to be collected from the same retailer location or from retailer locations within a threshold distance of each other, if the delivery locations for the new orders are within a threshold distance of each other, and if the delivery timeframe for the new orders are within a threshold time of each other.

The progress/routing module 223 receives information describing the progress of a picker servicing a batch of orders. Information describing the progress of a picker may indicate a location associated with the picker (e.g., a location of a picker client device 110 associated with the picker), a state of the picker (e.g., whether the picker is currently driving, collecting items, checking out at a retailer location, arriving at a retailer location or a delivery location, etc.), or a step associated with a state of the picker (e.g., collecting the third out of 10 items included in an order). Information describing the progress of a picker also may indicate tasks involved in servicing a batch of orders that have or have not been completed (e.g., items that have or have not yet been collected, orders that have or have not been delivered, etc.) or any other suitable types of information. Information describing the progress of a picker may be communicated to the data collection module 200 in association with other types of information (e.g., information describing the picker and the batch being serviced by the picker, a time at which the information was received, etc.), which the data collection module 200 may then store in the data store 240 (e.g., among picker data for the picker).

The progress/routing module 223 may receive information describing the progress of a picker by tracking the location of the picker through the picker client device 110 to determine when the picker arrives at a retailer location. When the picker arrives at the retailer location, the interface module 227 (described below) transmits a corresponding order to the picker client device 110 for display to the picker. As the picker uses the picker client device 110 to collect items at the retailer location, the progress/routing module 223 receives item identifiers for items that the picker has collected for the order. In some embodiments, the progress/routing module 223 receives images of items from the picker client device 110 and applies computer vision techniques to the images to identify the items depicted by the images. The progress/routing module 223 may track the progress of the picker as the picker collects items for an order and may transmit progress updates to the customer client device 100 that describe which items have been collected for the customer's order.

In some embodiments, the progress/routing module 223 also may receive information describing the progress of a picker by tracking the location of the picker within a retailer location. The progress/routing module 223 uses sensor data from the picker client device 110 or from sensors in the retailer location to determine the location of the picker in the retailer location. The progress/routing module 223 may transmit instructions to the picker client device 110 to display a map of the retailer location indicating where in the retailer location the picker is located. Additionally, the progress/routing module 223 may instruct the picker client device 110 to display the locations of items for the picker to collect, and the interface module 227 may display navigation instructions for how the picker can travel from their current location to the location of a next item to collect for an order.

The progress/routing module 223 also may determine when the picker has collected all of the items for an order. For example, the progress/routing module 223 may receive a message from the picker client device 110 indicating that all of the items for an order have been collected. Alternatively, the progress/routing module 223 may receive item identifiers for items collected by the picker and determine when all of the items in an order have been collected. When the progress/routing module 223 determines that the picker has completed an order, the interface module 227 transmits the delivery location for the order to the picker client device 110. The interface module 227 may also transmit navigation instructions to the picker client device 110 that specify how to travel from the retailer location to the delivery location, or to a subsequent retailer location for further item collection. The progress/routing module 223 tracks the location of the picker as the picker travels to the delivery location for an order, and updates the customer with the location of the picker so that the customer can track the progress of their order. In some embodiments, the progress/routing module 223 computes an estimated time of arrival for the picker at the delivery location and provides the estimated time of arrival to the customer.

In embodiments in which information describing the progress of a picker received by the progress/routing module 223 indicates a state of the picker, the progress/routing module 223 may infer the state of the picker based on the information. For example, based on information received from a picker client device 110 indicating a speed associated with the picker client device 110 that is greater than five miles an hour or information indicating the picker client device 110 has established a Bluetooth connection to a vehicle operated by the picker, the progress/routing module 223 may infer that the picker is driving. As an additional example, by tracking the location of a picker within a retailer location, the progress/routing module 223 may infer that the picker is checking out at the retailer location if the picker's location corresponds to a checkout stand.

The progress/routing module 223 may also determine a timeline for a batch of existing orders being serviced by a picker. The progress/routing module 223 may determine the timeline by computing an estimated amount of time that it would take for the picker to collect the items for each order and deliver the ordered items to a delivery location for the corresponding order. The progress/routing module 223 may determine the timeline based on various types of information. For example, the progress/routing module 223 may retrieve historical picker data for a picker stored in the data store 240 describing a time or a timespan during which the picker performed various tasks involved in servicing previous orders. In this example, the progress/routing module 223 also may retrieve order data stored in the data store 240 describing a batch of existing orders being serviced by the picker (e.g., items included in each order, a retailer location from which items included in each order are to be collected, a delivery location for each order, etc.). In the above example, based on the retrieved information and information describing the progress of the picker, the progress/routing module 223 may determine a timeline for the batch of existing orders being serviced by the picker (e.g., a number of minutes until the picker is likely to have delivered all the orders included in the batch).

The prediction module 224 may determine the current marketplace state. The current marketplace state may describe the time of day, orders placed with the online concierge system 140, a busyness associated with one or more retailer locations from which items included in a new or existing order are to be collected (e.g., an amount of congestion associated with checking out or a parking lot at each retailer location), or any other suitable types of information. The prediction module 224 may determine the current marketplace state based on various types of information received from one or more customer client devices 100, one or more picker client devices 110, one or more retailer computing systems 120, or any other suitable source. For example, if information describing the progress of a picker received by the progress/routing module 223 indicates that the picker is driving, but the picker has been associated with a location corresponding to a parking lot of a retailer location for the last 10 minutes, the prediction module 224 may determine that the parking lot of the retailer location is likely congested. As an additional example, if several new orders including items to be collected from a retailer location are received by the order receiving module 221 and information received by the progress/routing module 223 indicates that pickers in a checking out state at the retailer location are in this state for more than a threshold amount of time, the prediction module 224 may determine that the retailer location is likely busy. The prediction module 224 may communicate information describing the current marketplace state to the data collection module 200, which may store this information in the data store 240 in association with information describing the current time.

The prediction module 224 also may identify various types of information that it may use to predict one or more likelihoods associated with a picker described below or which the matching module 225 may use to match pickers with batches of new orders, as further described below. Examples of such types of information include: a set of attributes of a picker, a set of attributes of each order included in a batch of new or existing orders, or any other suitable types of information. For example, the prediction module 224 may identify a set of attributes of a picker based on picker data stored in the data store 240 including an average rate at which the picker collects items and an average number of hours the picker services orders (e.g., per day, on a given day of the week, etc.). As an additional example, based on order data stored in the data store 240, the prediction module 224 may identify a set of attributes of each order included in a batch of new or existing orders. In the above example, the attributes of each order may include a delivery location, information describing one or more items included in the order (e.g., a number of the items, a size of each item, etc.), a retailer location from which the item(s) are to be collected, a payment amount (e.g., a payrate, a tip amount, etc.), a delivery timeframe, etc.

The prediction module 224 also predicts a likelihood that a picker servicing a batch of existing orders will finish servicing the batch of existing orders within a threshold amount of time. For example, the prediction module 224 may predict a likelihood that a picker servicing a batch of existing orders will have delivered all the orders included in the batch within a threshold amount of time. The threshold amount of time may be fixed or it may be variable. For example, the threshold amount of time may be a fixed number of minutes (e.g., 10 minutes) from a current time. As an additional example, the threshold amount of time may be a variable number of minutes from a current time, in which the number of minutes is an average number of minutes that pickers available to service batches of new orders take to accept batches of new orders for servicing. In some embodiments, the prediction module 224 predicts a likelihood that a picker servicing a batch of existing orders will finish servicing the batch of existing orders within a threshold amount of time based on a timeline determined by the progress/routing module 223. For example, based on a timeline describing a number of minutes until a picker is likely to have delivered all the orders included in a batch of existing orders, the prediction module 224 may predict a likelihood that the picker will finish servicing the batch within a threshold amount of time. The prediction module 224 also may predict a likelihood that a picker servicing a batch of existing orders will finish servicing the batch of existing orders within a threshold amount of time based on other types of information. Examples of such types of information include: a set of attributes of the picker, information describing the progress of the picker with respect to servicing the batch of existing orders, a set of attributes of one or more existing orders included in the batch of existing orders, the current marketplace state, or any other suitable types of information. For example, suppose that attributes of each existing order included among a batch of existing orders being serviced by a picker indicate that items included in each order are to be collected from the same retailer location and that each existing order is to be delivered to a location very close to the retailer location. In this example, suppose also that information describing the progress of the picker indicates the picker has collected all the items included in the batch of existing orders and is checking out at the retailer location. Continuing with this example, based on the attributes of each existing order and the information describing the progress of the picker, the prediction module 224 may predict a high likelihood that the picker will finish servicing the batch of existing orders within a threshold amount of time (e.g., within the next 10 minutes). Alternatively, in the above example, suppose that the information describing the progress of the picker indicates the picker has not yet collected 20 items included in the batch of existing orders, that the current marketplace state indicates that the retailer location is very busy, and that attributes of the picker include an average item collection rate of one item every five minutes. Continuing with this example, based on the attributes of each existing order, attributes of the picker, the information describing the progress of the picker, and the current marketplace state, the prediction module 224 may predict a low likelihood that the picker will finish servicing the set of existing orders within the threshold amount of time. The prediction module 224 also may predict a likelihood that a picker servicing a batch of existing orders will finish servicing the batch of existing orders within a threshold amount of time using a batch servicing prediction model. The batch servicing prediction model is a machine learning model trained to predict a likelihood that a picker servicing a batch of existing orders will finish servicing the batch of existing orders within a threshold amount of time. To use the batch servicing prediction model, the prediction module 224 may access the model (e.g., from the data store 240) and apply the model to a set of inputs. The set of inputs may include various types of information described above (e.g., a set of attributes of a picker, information describing the progress of the picker with respect to servicing a batch of existing orders, a set of attributes of one or more existing orders included in the batch of existing orders, the current marketplace state, etc.). For example, the set of inputs may include attributes of each existing order included among a batch of existing orders being serviced by a picker, such as a number of items included in each order and a delivery location for each order. In this example, the set of inputs also may include information describing the progress of the picker, such as a number of existing orders included in the batch that the picker has delivered, a state of the picker (e.g., driving to a delivery location), and a location associated with the picker. The prediction module 224 may then receive an output corresponding to the predicted likelihood that the picker servicing the batch of existing orders will finish servicing the batch of existing orders within a threshold amount of time. Continuing with the above example, the prediction module 224 may receive an output from the batch servicing prediction model corresponding to a value (e.g., a score, a percentage, etc.), in which the value is proportional to the likelihood that the picker will finish servicing the batch within a threshold amount of time (e.g., within the next 10 minutes). In some embodiments, the batch servicing prediction model may be trained by the machine learning training module 230, as further described below.

Once the prediction module 224 predicts a likelihood that a picker servicing a batch of existing orders will finish servicing the batch of existing orders within a threshold amount of time, the prediction module 224 may determine whether the likelihood exceeds a threshold likelihood. For example, the prediction module 224 may compare a 72% likelihood that a picker servicing a batch of existing orders will finish servicing the batch of existing orders within the next 10 minutes to a threshold likelihood of 80%. In this example, based on the comparison, the prediction module 224 may determine that the likelihood does not exceed the threshold likelihood. Alternatively, in the above example, if the likelihood that the picker will finish servicing the batch of existing orders within the next 10 minutes is 83%, based on the comparison, the prediction module 224 may determine that the likelihood exceeds the threshold likelihood.

The prediction module 224 also predicts a likelihood that a picker servicing a batch of existing orders will accept a batch of new orders for servicing while servicing the batch of existing orders. The prediction module 224 may do so upon determining that a likelihood that the picker will finish servicing the batch of existing orders within a threshold amount of time exceeds a threshold likelihood. The prediction module 224 may predict a likelihood that a picker servicing a batch of existing orders will accept a batch of new orders for servicing while servicing the batch of existing orders based on various types of information. Examples of such types of information include: a set of attributes of the picker, information describing the progress of the picker with respect to servicing the batch of existing orders, a set of attributes of one or more orders (e.g., one or more new orders included in the batch of new orders and/or one or more existing orders included in the batch of existing orders), the current marketplace state, or any other suitable types of information. In some embodiments, the prediction module 224 may only use certain attributes of a picker describing sensitive or personal data (e.g., the picker's earnings, hours worked, etc.) if the picker consents. Furthermore, a likelihood that a picker will accept a batch of new orders for servicing while servicing a batch of existing orders may be predicted for a particular batch of new orders (e.g., based on a set of attributes of one or more new orders included in the particular batch) or for any batch of new orders. In some embodiments, if a likelihood that a picker servicing a batch of existing orders will accept a batch of new orders for servicing while servicing the batch of existing orders is less than a threshold likelihood, the matching module 225 (described below) does not match the picker with one or more batches of new orders.

The following examples illustrate how the prediction module 224 may predict a likelihood that a picker servicing a batch of existing orders will accept a batch of new orders for servicing while servicing the batch of existing orders. Suppose, for example, that information describing the progress of a picker servicing a batch of existing orders indicates the picker is at a retailer location and is almost finished collecting items included in the batch of existing orders. In this example, suppose also that attributes of the picker indicate that so far, the picker has been servicing orders for fewer than an average number of hours they service orders on a given day and has earned less than an average amount of earnings they earn on a given day. Continuing with this example, based on the attributes of the picker and the information describing the progress of the picker, the prediction module 224 may predict a high likelihood that the picker will accept a batch of new orders for servicing while servicing the batch of existing orders. In this example, the prediction module 224 also may predict the high likelihood based on attributes of each new order and/or each existing order (e.g., a high payment amount associated with servicing the batch of new orders and a retailer location from which items included in the batch of new orders are to be collected that is close to a delivery location for the batch of existing orders, etc.). In the above example, the prediction module 224 also may predict the high likelihood based on information describing the current marketplace state indicating that the retailer location from which items included in the batch of new orders are to be collected is not very busy. Alternatively, in the above example, suppose that the attributes of the picker indicate that so far, the picker has been servicing orders for more than an average number of hours they service orders on a given day and has earned more than an average amount of earnings they earn on a given day. In this example, based on the attributes of the picker and the information describing the progress of the picker, the prediction module 224 may predict a low likelihood that the picker will accept a batch of new orders for servicing while servicing the batch of existing orders. In the above example, the prediction module 224 also may predict the low likelihood based on attributes of each new order and/or each existing order (e.g., a low payment amount associated with servicing the batch of new orders and a retailer location from which items included in the batch of new orders are to be collected that is far from a delivery location for the batch of existing orders, etc.). In this example, the prediction module 224 also may predict the low likelihood based on information describing the current marketplace state indicating that the retailer location from which items included in the batch of new orders are to be collected is very busy.

The prediction module 224 also may predict a likelihood that a picker servicing a batch of existing orders will accept a batch of new orders for servicing while servicing the batch of existing orders using a batch acceptance prediction model. The batch acceptance prediction model is a machine learning model trained to predict a likelihood that a picker servicing a batch of existing orders will accept a batch of new orders for servicing while servicing the batch of existing orders. To use the batch acceptance prediction model, the prediction module 224 may access the model (e.g., from the data store 240) and apply the model to a set of inputs. The set of inputs may include various types of information described above (e.g., a set of attributes of a picker, information describing the progress of the picker with respect to servicing a batch of existing orders, a set of attributes of one or more orders included in a batch of new orders and/or the batch of existing orders, the current marketplace state, etc.). For example, the set of inputs may include information describing the progress of the picker, such as a number of orders included in a batch of existing orders that the picker has delivered, a state of the picker (e.g., driving to a delivery location), and a location associated with the picker. In this example, the set of inputs also may include a set of attributes of the picker, such as timeframes within which the picker is willing to service orders, a number of hours the picker has been servicing orders so far that day, an average number of hours the picker services orders on a given day, an amount of earnings for the picker so far that day, an average amount of earnings for the picker on a given day, etc. The prediction module 224 may then receive an output corresponding to the predicted likelihood that the picker servicing the batch of existing orders will accept a batch of new orders for servicing while servicing the batch of existing orders. Continuing with the above example, the prediction module 224 may receive an output from the batch acceptance prediction model corresponding to a value (e.g., a score, a percentage, etc.), in which the value is proportional to a likelihood that the picker will accept a batch of new orders for servicing while servicing the batch of existing orders. In some embodiments, the batch acceptance prediction model may be trained by the machine learning training module 230, as further described below.

The matching module 225 may match batches of new orders with pickers for service based on picker data and order data for the orders included in the batches. For example, the matching module 225 matches a batch of new orders with a picker based on the picker's location and the retailer location from which the ordered items are to be collected. The matching module 225 may also match a batch of new orders with a picker based on how many items are in each order, a vehicle operated by the picker, one or more delivery locations, the picker's preferences for how far to travel to deliver an order, the picker's ratings by customers, or how often a picker agrees to service a batch of orders.

The matching module 225 also may match batches of new orders with pickers based on a likelihood that a picker will accept a batch of new orders for servicing while servicing a batch of existing orders. For example, suppose that the prediction module 224 has predicted a likelihood that a picker servicing a batch of existing orders will accept a batch of new orders for servicing while servicing the batch of existing orders. In this example, if the predicted likelihood is for a particular batch of new orders, the likelihood that the matching module 225 matches the particular batch with the picker may be proportional to the predicted likelihood. The matching module 225 also may match batches of new orders with pickers by determining a number of pickers to match with each batch of new orders, a number of batches of new orders to match with each picker, etc. based on a likelihood that a picker will accept a batch of new orders for servicing while servicing a batch of existing orders. In the above example, a number of additional pickers with which the particular batch is matched may be inversely proportional to the predicted likelihood. Alternatively, in the above example, if the predicted likelihood is for any batch of new orders, the matching module 225 may match the picker with a number of batches of new orders that is proportional to the predicted likelihood.

The matching module 225 also may match batches of new orders with pickers based on additional types of information. These types of information may include: an amount of time that is likely to elapse before a picker servicing a batch of existing orders may begin to service a batch of new orders, an amount of time that a picker is likely to take to accept a batch of new orders for servicing, a delivery timeframe and/or a delivery location for each order included in a batch of new or existing orders, or any other suitable types of information. For example, based on a timeline for a batch of existing orders being serviced by a picker determined by the progress/routing module 223, the matching module 225 may determine an amount of time that is likely to elapse before the picker may begin to service a batch of new orders. In this example, the matching module 225 also may determine amounts of time that other pickers are likely to take to accept batches of new orders for servicing (e.g., based on picker data stored in the data store 240 describing an average amount of time that each picker available to service orders takes to accept a batch of new orders for servicing). Continuing with this example, the matching module 225 may compare the amount of time that is likely to elapse before the picker servicing the batch of existing orders may begin to service a batch of new orders with the amounts of time that other pickers are likely to take to accept batches of new orders for servicing and match batches of new orders with pickers based on the comparison. In the above example, the matching module 225 also may take into account a delivery timeframe and a delivery location for each new order included in each batch of new orders, such that each batch may be matched with one or more pickers in a way that minimizes the likelihood that the new order(s) will be delivered late.

The matching module 225 may match a picker with up to a maximum number of batches of new orders. The maximum number of batches of new orders may be determined based on one or more attributes of the picker, one or more attributes of each batch of new orders, the current marketplace state, timeframes within which other pickers are willing to service orders, or any other suitable types of information. For example, the matching module 225 may determine a maximum number of batches of new orders that may be matched with a picker based on an average number of hours the picker services orders per day, a number of hours the picker has serviced orders so far that day, an average amount of earnings for the picker per day, and an amount of earnings for the picker so far that day. In this example, the maximum number of batches of new orders that may be matched with the picker may be inversely proportional to a ratio of the number of hours the picker has serviced orders so far that day to the average number of hours the picker services orders per day or to a ratio of the amount of earnings for the picker so far that day to the average amount of earnings for the picker per day. In the above example, the maximum number of batches also may be inversely proportional to a number of additional pickers available to service orders, a number of items included in each batch of new orders, etc.

The request module 226 determines whether the matching module 225 has matched one or more batches of new orders with a picker and generates one or more requests to service the batch(es) based on the determination. The request module 226 may generate a request to service a batch of new orders upon determining that the matching module 225 has matched the batch with a picker. A request to service a batch of new orders may include various types of information associated with the batch. For example, a request to service a batch of new orders may include various types of information associated with each new order included in the batch, such as a delivery location associated with each new order, information describing one or more items included in each new order, an amount of pay associated with each new order, a delivery timeframe for each new order, etc. A request to service a batch of new orders also may include one or more interactive elements (e.g., buttons) that allow a picker to accept or reject the batch for servicing.

Once a request to service a batch of new orders has been generated by the request module 226, the interface module 227 may send it for display to a picker client device 110 associated with a picker (e.g., as a push notification, as a text message, etc.). The picker may then accept the batch for servicing. For example, if a request to service a batch of new orders is sent to a picker client device 110 associated with a picker as a push notification, upon clicking on the notification, the picker may be presented with details about the batch and options to accept or decline the batch for servicing. If a picker accepts a batch of new orders for servicing while servicing a batch of existing orders, the picker may begin servicing the batch of new orders once they have finished servicing the batch of existing orders. The interface module 227 may also transmit navigation instructions from the picker's current location to a retailer location associated with an order included in the batch. If the batch includes items to collect from multiple retailer locations, information transmitted by the interface module 227 identifies the retailer locations to the picker and may also specify a sequence in which the picker should visit the retailer locations. In some embodiments, the interface module 227 determines when to transmit a request to service a batch of orders to a picker based on a delivery timeframe requested by each customer who placed an order included in the batch. As described above, the progress/routing module 223 computes an estimated amount of time that it would take for a picker to collect the items for each order and deliver the ordered items to the delivery location for the order. Based on this estimate, the interface module 227 transmits a request to service the batch of orders to a picker at a time such that, if the picker immediately services the batch, the picker is likely to deliver each order at a time within the timeframe. Thus, the interface module 227 may delay in transmitting a request to service the batch of new orders to a picker if the timeframe is far enough in the future.

In some embodiments, even if the matching module 225 has matched a batch of new orders with a picker and the request module 226 has generated a request to service the batch, the interface module 227 determines whether to send the request for display to a picker client device 110 associated with the picker and may or may not send the request based on the determination. The interface module 227 may make this determination based on a number of requests to service batches of new orders sent to the picker client device 110 (e.g., within a timespan), a frequency with which requests to service batches of new orders are being sent to the picker client device 110, or any other suitable types of information. For example, suppose that a constraint limits a number of requests to service batches of new orders that may be sent to pickers servicing batches of existing orders to 15 requests within the same hour. In this example, the interface module 227 may determine that a request to service a batch of new orders should not be sent to a picker client device 110 if 15 requests to service batches of new orders have already been sent to the picker client device 110 within the last hour and if the picker is servicing a batch of existing orders. The interface module 227 may send a request to service a batch of new orders to a picker client device 110 upon determining that the request may be sent. If the interface module 227 determines that a request to service a batch of new orders should not be sent to a picker client device 110, the interface module 227 may communicate information indicating this to the matching module 225, which may then match the batch of new orders associated with the request with a different picker. Similarly, if the interface module 227 sends a request to service a batch of new orders to a picker client device 110, but the request is declined or is not accepted within a threshold amount of time, the interface module 227 may communicate information indicating this to the matching module 225, which may match the batch of new orders associated with the request with a different picker.

In some embodiments, the communication module 228 facilitates communication between the customer client device 100 and the picker client device 110. As noted above, a customer may use a customer client device 100 to send a message to the picker client device 110. The communication module 228 receives the message from the customer client device 100 and transmits the message to the picker client device 110 for presentation to the picker. The picker may use the picker client device 110 to send a message to the customer client device 100 in a similar manner.

The payment module 229 coordinates payment by the customer for the order. The payment module 229 uses payment information provided by the customer (e.g., a credit card number or a bank account) to receive payment for the order. In some embodiments, the payment module 229 stores the payment information for use in subsequent orders by the customer. The payment module 229 computes a total cost for the order and charges the customer that cost. The payment module 229 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model is used by the machine learning model to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

In embodiments in which the prediction module 224 accesses the batch servicing prediction model that is trained to predict a likelihood that a picker servicing a batch of existing orders will finish servicing the batch of existing orders within a threshold amount of time, the machine learning training module 230 may train the batch servicing prediction model. The machine learning training module 230 may train the batch servicing prediction model via supervised learning based on one or more types of historical data (e.g., historical picker data, historical marketplace state data, historical order data, etc.), one or more types of attributes (e.g., attributes of previous orders, attributes of pickers, etc.), or any other suitable types of information. For example, the machine learning training module 230 may train the batch servicing prediction model via supervised learning based on historical order data describing orders serviced by pickers and amounts of time required to service the orders.

To illustrate an example of how the batch servicing prediction model may be trained, suppose that the machine learning training module 230 receives a set of training examples. In this example, the set of training examples may include attributes of pickers, such as how often each picker services orders for the online concierge system 140, a customer rating for each picker, retailers from which each picker has collected items, each picker's preferred retailer for collecting items, an average rate at which each picker collects items, etc. In this example, the set of training examples also may include each picker's progress while servicing each order, such as a time or a timespan during which the picker performed each task involved in servicing the order (e.g., collecting each item in the order, driving to a retailer location or a delivery location for the order, checking out, delivering the order, etc.). In the above example, the set of training examples also may include attributes of previous orders serviced by the pickers, such as information describing a number of items included in each order, types of the items, retailer locations from which the items were collected, instructions for collecting the items, delivery locations for the orders, etc. Continuing with this example, the set of training examples further may include the marketplace state at the times that the pickers serviced the previous orders (e.g., the time of day, other orders placed with the online concierge system 140, a busyness associated with retailer locations from which items included in the previous orders were collected, etc.). In the above example, the machine learning training module 230 also may receive labels which represent expected outputs of the batch servicing prediction model, in which a label indicates, as each picker made progress servicing a batch of previous orders, whether the picker finished servicing the batch within a threshold amount of time (e.g., a number of minutes). Continuing with this example, the machine learning training module 230 may then train the batch servicing prediction model based on the attributes, as well as the labels by comparing its output from input data of each training example to the label for the training example.

In embodiments in which the prediction module 224 accesses the batch acceptance prediction model that is trained to predict a likelihood that a picker servicing a batch of existing orders will accept a batch of new orders for servicing while servicing the batch of existing orders, the machine learning training module 230 may train the batch acceptance prediction model. The machine learning training module 230 may train the batch acceptance prediction model via supervised learning (e.g., using a gradient boosted decision tree classifier) based on one or more types of historical data (e.g., historical picker data, historical marketplace state data, historical order data, etc.), one or more types of attributes (e.g., attributes of previous orders, attributes of pickers, etc.), or any other suitable types of information. For example, the machine learning training module 230 may train the batch acceptance prediction model based on historical picker data describing acceptance by pickers of requests to service batches of new orders while servicing batches of existing orders. The batch acceptance prediction model may be retrained as the machine learning training module 230 receives more data (e.g., information describing whether requests to service batches of new orders were accepted, information describing each request, etc.).

To illustrate an example of how the batch acceptance prediction model may be trained, suppose that the machine learning training module 230 receives a set of training examples. In this example, the set of training examples may include attributes of pickers servicing batches of existing orders, such as an average number of hours each picker services orders (e.g., per day, on a given day of the week, etc.), an average amount of earnings for each picker (e.g., per day, on a given day of the week, etc.), each picker's preferences, an average rate at which each picker collects items, etc. In the above example, the set of training examples also may include information describing the progress of each picker, such as each picker's location, a state of the picker, a step associated with a state of the picker, etc., at the time a request to service a batch of new orders was sent to a picker client device 110 associated with the picker. In this example, the set of training examples also may include attributes of each new order included in a batch of new orders associated with each request and of each existing order being serviced by a picker (e.g., number of items included in each order, a payment amount, a delivery location, a delivery timeframe, etc.). In the above example, the set of training examples further may include information describing a marketplace state each time a request was sent to a picker client device 110 associated with a picker (e.g., the time of day, a busyness of a retailer location associated with each new and existing order, a congestion of a parking lot of each retailer location, etc.). In this example, the machine learning training module 230 also may receive labels which represent expected outputs of the batch acceptance prediction model, in which a label indicates whether each picker accepted a request to service a batch of new orders sent to a picker client device 110 associated with the picker (e.g., within a threshold amount of time). Continuing with this example, the machine learning training module 230 may then train the batch acceptance prediction model based on the attributes as well as the labels by comparing its output from input data of each training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In situations in which the training example includes a label, the loss function is also based on the label for the training example. Some example loss functions include the mean square error function, the mean absolute error, the hinge loss function, and the cross-entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores customer data, item data, order data, picker data, and marketplace data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

### Predicting a Likelihood That a Picker Servicing a Batch of Existing Orders Placed With an Online Concierge System Will Accept a Batch of New Orders For Servicing

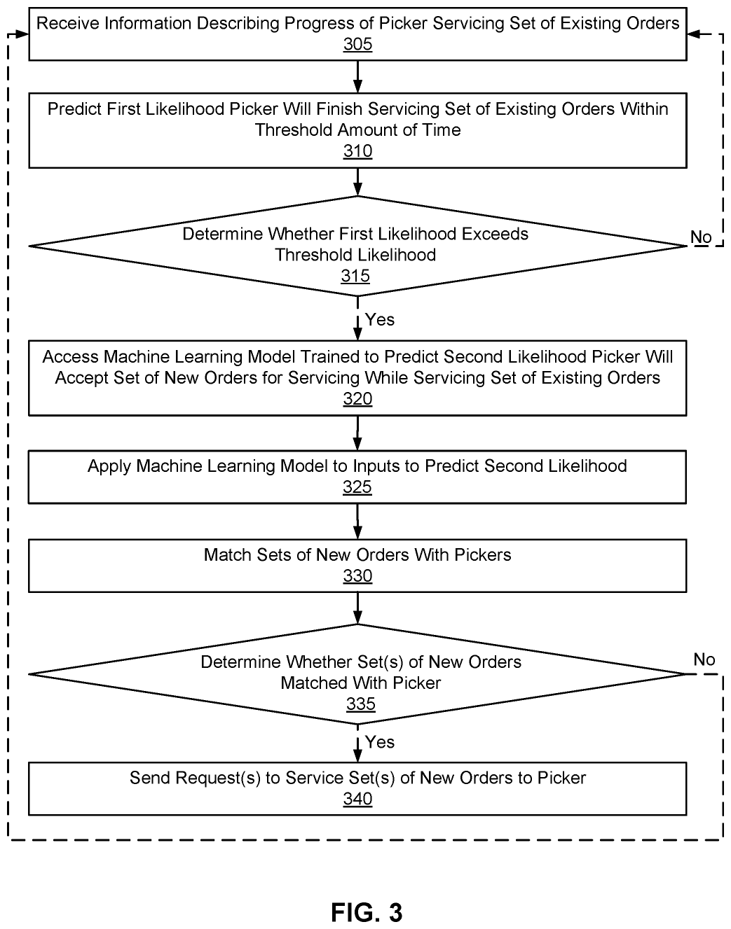

FIG. 3 is a flowchart of a method for predicting a likelihood that a picker servicing a batch of existing orders placed with an online concierge system 140 will accept a batch of new orders for servicing, in accordance with one or more embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system 140 without human intervention.

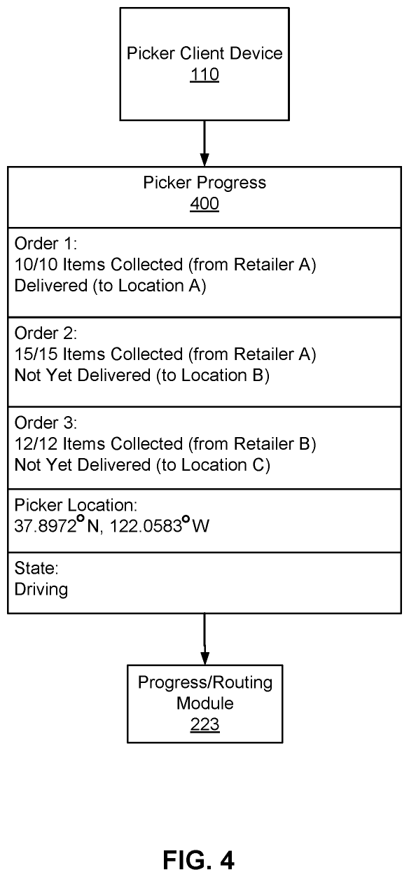

The online concierge system 140 receives 305 (e.g., via the progress/routing module 223) information describing the progress of a picker servicing a batch of existing orders. The information describing the progress of the picker may indicate a location associated with the picker (e.g., a location of a picker client device 110 associated with the picker), a state of the picker (e.g., whether the picker is currently driving, collecting items, checking out at a retailer location, arriving at a retailer location or a delivery location, etc.), or a step associated with a state of the picker (e.g., collecting the third out of 10 items included in an existing order). The information describing the progress of the picker also may indicate tasks involved in servicing the batch of existing orders that have or have not been completed (e.g., items that have or have not yet been collected, existing orders that have or have not been delivered, etc.) or any other suitable types of information. FIG. 4 illustrates an example of information describing the progress 400 of a picker servicing a batch of existing orders, in accordance with one or more embodiments. As shown in this example, the information describing the progress 400 of the picker indicates that the batch of existing orders being serviced by the picker includes three orders (Order 1, Order 2, and Order 3). In this example, the information describing the progress 400 of the picker also indicates that the picker has collected all the items included in Order 1, Order 2, and Order 3. In the above example, the information describing the progress 400 of the picker also indicates that the picker has delivered Order 1, but has not yet delivered Order 2 or Order 3. Furthermore, in this example, the information describing the progress 400 of the picker indicates that the picker is currently driving and the picker's location (37.8972° N, 122.0583° W).

The online concierge system 140 may receive 305 the information describing the progress 400 of the picker by tracking the location of the picker as the picker travels to a retailer location or a delivery location for an existing order (e.g., via the picker client device 110 associated with the picker), or as the picker travels within a retailer location (e.g., using sensor data from the picker client device 110 or from sensors in the retailer location). The online concierge system 140 also may receive 305 this information by tracking the progress 400 of the picker as the picker collects items for an existing order. For example, the online concierge system 140 may receive 305 the information describing the progress 400 of the picker in the form of item identifiers for items included in an existing order that the picker has collected or in the form of a message indicating that all of the items for an existing order have been collected from the picker client device 110 associated with the picker. In the above example, the online concierge system 140 also or alternatively may receive 305 the information describing the progress 400 of the picker in the form of images of items included in the existing order that the picker has collected, which the online concierge system 140 may then identify by applying computer vision techniques to the images.

In embodiments in which the information describing the progress 400 of the picker received 305 by the online concierge system 140 indicates a state of the picker, the online concierge system 140 may infer (e.g., using the progress/routing module 223) the state of the picker based on the information. For example, based on information received 305 from the picker client device 110 indicating a speed associated with the picker client device 110 that is greater than five miles an hour or information indicating the picker client device 110 has established a Bluetooth connection to a vehicle operated by the picker, the online concierge system 140 may infer that the picker is driving. As an additional example, by tracking the location of the picker within a retailer location, the online concierge system 140 may infer that the picker is checking out at the retailer location if the picker's location corresponds to a checkout stand.

The online concierge system 140 also may determine (e.g., using the progress/routing module 223) a timeline for the batch of existing orders being serviced by the picker. The online concierge system 140 may determine the timeline by computing an estimated amount of time that it would take for the picker to collect the items for each existing order and deliver the ordered items to a delivery location for the corresponding order. The online concierge system 140 may determine the timeline based on various types of information. For example, the online concierge system 140 may retrieve historical picker data for the picker (e.g., stored in the data store 240) describing a time or a timespan during which the picker performed various tasks involved in servicing previous orders. In this example, the online concierge system 140 also may retrieve order data (e.g., stored in the data store 240) describing the batch of existing orders being serviced by the picker (e.g., items included in each order, a retailer location from which items included in each order are to be collected, a delivery location for each order, etc.). In the above example, based on the retrieved information and information describing the progress 400 of the picker, the online concierge system 140 may determine a timeline for the batch of existing orders being serviced by the picker (e.g., a number of minutes until the picker is likely to have delivered all the orders included in the batch).

The online concierge system 140 also may identify (e.g., using the prediction module 224) various types of information that it may use to predict one or more likelihoods associated with the picker described below or which the online concierge system 140 may use to match pickers with batches of new orders, as further described below (in step 330). Examples of such types of information include: a set of attributes of the picker, a set of attributes of each order included in a batch of new orders or the batch of existing orders, or any other suitable types of information. For example, the online concierge system 140 may identify a set of attributes of the picker based on picker data (e.g., stored in the data store 240) including an average rate at which the picker collects items and an average number of hours the picker services orders (e.g., per day, on a given day of the week, etc.). As an additional example, based on order data (e.g., stored in the data store 240), the online concierge system 140 may identify a set of attributes of each order included in a batch of new orders or in the batch of existing orders being serviced by the picker. In the above example, the attributes of each order may include a delivery location, information describing one or more items included in the order (e.g., a number of the items, a size of each item, etc.), a retailer location from which the item(s) are to be collected, a payment amount (e.g., a payrate, a tip amount, etc.), a delivery timeframe, etc.

Additionally, the online concierge system 140 may determine (e.g., using the prediction module 224) the current marketplace state. The current marketplace state may describe the time of day, orders placed with the online concierge system 140, a busyness associated with one or more retailer locations from which items included in a new or existing order are to be collected (e.g., an amount of congestion associated with checking out or a parking lot at each retailer location), or any other suitable types of information. The online concierge system 140 may determine the current marketplace state based on various types of information received from one or more customer client devices 100, one or more picker client devices 110, one or more retailer computing systems 120, or any other suitable source. For example, if the information describing the progress 400 of the picker received 305 by the online concierge system 140 indicates that the picker is driving, but the picker has been associated with a location corresponding to a parking lot of a retailer location for the last 10 minutes, the online concierge system 140 may determine that the parking lot of the retailer location is likely congested. As an additional example, if several new orders including items to be collected from a retailer location are received by the online concierge system 140 (e.g., via the order receiving module 221) and information received by the online concierge system 140 (e.g., via the progress/routing module 223) indicates that pickers in a checking out state at the retailer location are in this state for more than a threshold amount of time, the online concierge system 140 may determine that the retailer location is likely busy.

Referring back to FIG. 3, the online concierge system 140 then predicts 310 (e.g., using the prediction module 224) a likelihood that the picker will finish servicing the batch of existing orders within a threshold amount of time. For example, the online concierge system 140 may predict 310 a likelihood that the picker will have delivered all the orders included in the batch of existing orders within the threshold amount of time. The threshold amount of time may be fixed or it may be variable. For example, the threshold amount of time may be a fixed number of minutes (e.g., 10 minutes) from a current time. As an additional example, the threshold amount of time may be a variable number of minutes from a current time, in which the number of minutes is an average number of minutes that pickers available to service batches of new orders take to accept batches of new orders for servicing. In some embodiments, the online concierge system 140 predicts 310 the likelihood that the picker will finish servicing the batch of existing orders within the threshold amount of time based on a timeline determined by the online concierge system 140. For example, based on a timeline describing a number of minutes until the picker is likely to have delivered all the orders included in the batch of existing orders, the online concierge system 140 may predict 310 the likelihood that the picker will finish servicing the batch within the threshold amount of time.

The online concierge system 140 also may predict 310 the likelihood that the picker will finish servicing the batch of existing orders within the threshold amount of time based on other types of information. Examples of such types of information include: a set of attributes of the picker, information describing the progress 400 of the picker with respect to servicing the batch of existing orders, a set of attributes of one or more existing orders included in the batch of existing orders, the current marketplace state, or any other suitable types of information. For example, suppose that attributes of each existing order included among the batch of existing orders being serviced by the picker indicate that items included in each order are to be collected from the same retailer location and that each existing order is to be delivered to a location very close to the retailer location. In this example, suppose also that information describing the progress 400 of the picker indicates the picker has collected all the items included in the batch of existing orders and is checking out at the retailer location. Continuing with this example, based on the attributes of each existing order and the information describing the progress 400 of the picker, the online concierge system 140 may predict 310 a high likelihood that the picker will finish servicing the batch of existing orders within the threshold amount of time (e.g., within the next 10 minutes). Alternatively, in the above example, suppose that the information describing the progress 400 of the picker indicates the picker has not yet collected 20 items included in the batch of existing orders, that the current marketplace state indicates that the retailer location is very busy, and that attributes of the picker include an average item collection rate of one item every five minutes. Continuing with this example, based on the attributes of each existing order, attributes of the picker, the information describing the progress 400 of the picker, and the current marketplace state, the online concierge system 140 may predict 310 a low likelihood that the picker will finish servicing the set of existing orders within the threshold amount of time.

The online concierge system 140 also may predict 310 the likelihood that the picker will finish servicing the batch of existing orders within the threshold amount of time using a batch servicing prediction model. The batch servicing prediction model is a machine learning model trained to predict a likelihood that a picker servicing a batch of existing orders will finish servicing the batch of existing orders within a threshold amount of time. To use the batch servicing prediction model, the online concierge system 140 may access (e.g., using the prediction module 224) the model (e.g., from the data store 240) and apply (e.g., using the prediction module 224) the model to a set of inputs. The set of inputs may include various types of information described above (e.g., a set of attributes of the picker, information describing the progress 400 of the picker with respect to servicing the batch of existing orders, a set of attributes of one or more existing orders included in the batch of existing orders, the current marketplace state, etc.). For example, the set of inputs may include attributes of each existing order included among the batch of existing orders being serviced by the picker, such as a number of items included in each order and a delivery location for each order. In this example, the set of inputs also may include information describing the progress 400 of the picker, such as a number of existing orders included in the batch that the picker has delivered, a state of the picker (e.g., driving to a delivery location), and a location associated with the picker. The online concierge system 140 may then receive an output corresponding to the predicted likelihood that the picker servicing the batch of existing orders will finish servicing the batch of existing orders within the threshold amount of time. Continuing with the above example, the online concierge system 140 may receive an output from the batch servicing prediction model corresponding to a value (e.g., a score, a percentage, etc.), in which the value is proportional to the likelihood that the picker will finish servicing the batch within the threshold amount of time (e.g., within the next 10 minutes). In some embodiments, the batch servicing prediction model may be trained by the online concierge system 140 (e.g., using the machine learning training module 230).

Once the online concierge system 140 predicts 310 the likelihood that the picker will finish servicing the batch of existing orders within the threshold amount of time, the online concierge system 140 may determine 315 (e.g., using the prediction module 224) whether the likelihood exceeds a threshold likelihood. For example, the online concierge system 140 may compare a 72% likelihood that the picker will finish servicing the batch of existing orders within the next 10 minutes to a threshold likelihood of 80%. In this example, based on the comparison, the online concierge system 140 may determine 315 that the likelihood does not exceed the threshold likelihood. Alternatively, in the above example, if the likelihood that the picker will finish servicing the batch of existing orders within the next 10 minutes is 83%, based on the comparison, the online concierge system 140 may determine 315 that the likelihood exceeds the threshold likelihood. If the online concierge system 140 determines 315 that the likelihood that the picker will finish servicing the batch of existing orders within the threshold amount of time does not exceed the threshold likelihood, one or more of the steps described above may be repeated (e.g., by proceeding back to step 305).

Responsive to determining 315 that the likelihood that the picker will finish servicing the batch of existing orders within the threshold amount of time exceeds the threshold likelihood, the online concierge system 140 may then predict (e.g., using the prediction module 224) a likelihood that the picker will accept a batch of new orders for servicing while servicing the batch of existing orders. The online concierge system 140 may do so based on various types of information. Examples of such types of information include: a set of attributes of the picker, information describing the progress 400 of the picker with respect to servicing the batch of existing orders, a set of attributes of one or more orders (e.g., one or more new orders included in the batch of new orders and/or one or more existing orders included in the batch of existing orders), the current marketplace state, or any other suitable types of information. In some embodiments, the online concierge system 140 may only use certain attributes of the picker describing sensitive or personal data (e.g., the picker's earnings, hours worked, etc.) if the picker consents. Furthermore, the likelihood that the picker will accept the batch of new orders for servicing while servicing the batch of existing orders may be predicted for a particular batch of new orders (e.g., based on a set of attributes of one or more new orders included in the particular batch) or for any batch of new orders. In some embodiments, if the likelihood that the picker will accept the batch of new orders for servicing while servicing the batch of existing orders is less than a threshold likelihood, the online concierge system 140 does not match the picker with one or more batches of new orders (as described below in step 330).

The following examples illustrate how the online concierge system 140 may predict the likelihood that the picker will accept the batch of new orders for servicing while servicing the batch of existing orders. Suppose, for example, that information describing the progress 400 of the picker servicing the batch of existing orders indicates the picker is at a retailer location and is almost finished collecting items included in the batch of existing orders. In this example, suppose also that attributes of the picker indicate that so far, the picker has been servicing orders for fewer than an average number of hours they service orders on a given day and has earned less than an average amount of earnings they earn on a given day. Continuing with this example, based on the attributes of the picker and the information describing the progress 400 of the picker, the online concierge system 140 may predict a high likelihood that the picker will accept the batch of new orders for servicing while servicing the batch of existing orders. In this example, the online concierge system 140 also may predict the high likelihood based on attributes of each new order and/or each existing order (e.g., a high payment amount associated with servicing the batch of new orders and a retailer location from which items included in the batch of new orders are to be collected that is close to a delivery location for the batch of existing orders, etc.). In the above example, the online concierge system 140 also may predict the high likelihood based on information describing the current marketplace state indicating that the retailer location from which items included in the batch of new orders are to be collected is not very busy. Alternatively, in the above example, suppose that the attributes of the picker indicate that so far, the picker has been servicing orders for more than an average number of hours they service orders on a given day and has earned more than an average amount of earnings they earn on a given day. In this example, based on the attributes of the picker and the information describing the progress 400 of the picker, the online concierge system 140 may predict a low likelihood that the picker will accept the batch of new orders for servicing while servicing the batch of existing orders. In the above example, the online concierge system 140 also may predict the low likelihood based on attributes of each new order and/or each existing order (e.g., a low payment amount associated with servicing the batch of new orders and a retailer location from which items included in the batch of new orders are to be collected that is far from a delivery location for the batch of existing orders, etc.). In this example, the online concierge system 140 also may predict the low likelihood based on information describing the current marketplace state indicating that the retailer location from which items included in the batch of new orders are to be collected is very busy.

The online concierge system 140 also may predict the likelihood that the picker will accept the batch of new orders for servicing while servicing the batch of existing orders using a batch acceptance prediction model. The batch acceptance prediction model is a machine learning model trained to predict a likelihood that a picker servicing a batch of existing orders will accept a batch of new orders for servicing while servicing the batch of existing orders. To use the batch acceptance prediction model, the online concierge system 140 may access 320 (e.g., using the prediction module 224) the model (e.g., from the data store 240) and apply 325 (e.g., using the prediction module 224) the model to a set of inputs. For example, the online concierge system 140 may apply the model to various types of information described above (e.g., a set of attributes of the picker, information describing the progress 400 of the picker with respect to servicing the batch of existing orders, a set of attributes of one or more orders included in the batch of new orders and/or the batch of existing orders, the current marketplace state, etc.). For example, the set of inputs may include information describing the progress 400 of the picker, such as a number of orders included in the batch of existing orders that the picker has delivered, a state of the picker (e.g., driving to a delivery location), and a location associated with the picker. In this example, the set of inputs also may include a set of attributes of the picker, such as timeframes within which the picker is willing to service orders, a number of hours the picker has been servicing orders so far that day, an average number of hours the picker services orders on a given day, an amount of earnings for the picker so far that day, an average amount of earnings for the picker on a given day, etc. The online concierge system 140 may then receive an output corresponding to the predicted likelihood that the picker servicing the batch of existing orders will accept the batch of new orders for servicing while servicing the batch of existing orders. Continuing with the above example, the online concierge system 140 may receive an output from the batch acceptance prediction model corresponding to a value (e.g., a score, a percentage, etc.), in which the value is proportional to the likelihood that the picker will accept the batch of new orders for servicing while servicing the batch of existing orders.

In some embodiments, the batch acceptance prediction model may be trained by the online concierge system 140 (e.g., using the machine learning training module 230). The online concierge system 140 may train the batch acceptance prediction model via supervised learning (e.g., using a gradient boosted decision tree classifier) based on one or more types of historical data (e.g., historical picker data, historical marketplace state data, historical order data, etc.), one or more types of attributes (e.g., attributes of previous orders, attributes of pickers, etc.), or any other suitable types of information. For example, the online concierge system 140 may train the batch acceptance prediction model based on historical picker data describing acceptance by pickers of requests to service batches of new orders while servicing batches of existing orders. The batch acceptance prediction model may be retrained as the online concierge system 140 receives more data (e.g., information describing whether requests to service batches of new orders are accepted, information describing each request, etc.).

To illustrate an example of how the batch acceptance prediction model may be trained, suppose that the online concierge system 140 receives a set of training examples. In this example, the set of training examples may include attributes of pickers servicing batches of existing orders, such as an average number of hours each picker services orders (e.g., per day, on a given day of the week, etc.), an average amount of earnings for each picker (e.g., per day, on a given day of the week, etc.), each picker's preferences, an average rate at which each picker collects items, etc. In the above example, the set of training examples also may include information describing the progress 400 of each picker, such as each picker's location, a state of the picker, a step associated with a state of the picker, etc., at the time a request to service a batch of new orders was sent to a picker client device 110 associated with the picker. In this example, the set of training examples also may include attributes of each new order included in a batch of new orders associated with each request and of each existing order being serviced by a picker (e.g., number of items included in each order, a payment amount, a delivery location, a delivery timeframe, etc.). In the above example, the set of training examples further may include information describing a marketplace state each time a request was sent to a picker client device 110 associated with a picker (e.g., the time of day, a busyness of a retailer location associated with each new and existing order, a congestion of a parking lot of each retailer location, etc.). In this example, the online concierge system 140 also may receive labels which represent expected outputs of the batch acceptance prediction model, in which a label indicates whether each picker accepted a request to service a batch of new orders sent to a picker client device 110 associated with the picker (e.g., within a threshold amount of time). Continuing with this example, the online concierge system 140 may then train the batch acceptance prediction model based on the attributes as well as the labels by comparing its output from input data of each training example to the label for the training example.

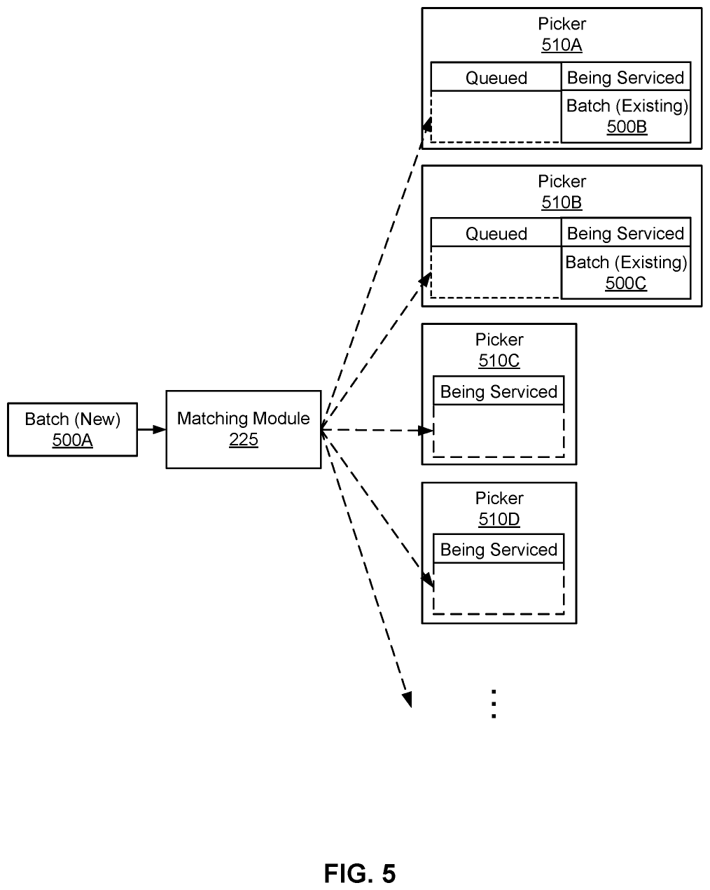

The online concierge system 140 then matches 330 (e.g., using the matching module 225) batches of new orders with pickers. FIG. 5 illustrates an example of matching 330 a batch 500 of new orders with one or more pickers 510, in accordance with one or more embodiments. As shown in FIG. 5, the pickers 510 with which the online concierge system 140 may match 330 a batch 500A of new orders may include one or more pickers 510A-B who are servicing batches 500B-C of existing orders and one or more pickers 510C-D who are not actively servicing batches 500B-C of existing orders. The online concierge system 140 may match 330 the batches 500 of new orders with pickers 510 based on the likelihood that the picker 510 will accept the batch 500 of new orders for servicing while servicing the batch 500 of existing orders. For example, if the likelihood that the picker 510 will accept the batch 500 of new orders for servicing while servicing the batch 500 of existing orders predicted by the online concierge system 140 is for a particular batch 500 of new orders, the likelihood that the online concierge system 140 matches 330 the particular batch 500 with the picker 510 may be proportional to the predicted likelihood. The online concierge system 140 also may match 330 the batches 500 of new orders with pickers 510 by determining a number of pickers 510 to match 330 with each batch 500 of new orders, a number of batches 500 of new orders to match 330 with each picker 510, etc. based on the likelihood that the picker 510 will accept the batch 500 of new orders for servicing while servicing the batch 500 of existing orders. In the above example, a number of additional pickers 510 with which the particular batch 500 is matched may be inversely proportional to the predicted likelihood. Alternatively, in the above example, if the predicted likelihood is for any batch 500 of new orders, the online concierge system 140 may match 330 the picker 510 with a number of batches 500 of new orders that is proportional to the predicted likelihood.

The online concierge system 140 also may match 330 the batches 500 of new orders with the pickers 510 based on additional types of information. These types of information may include: an amount of time that is likely to elapse before the picker 510 servicing the batch 500 of existing orders may begin to service a batch 500 of new orders, an amount of time that another picker 510 is likely to take to accept a batch 500 of new orders for servicing, a delivery timeframe and/or a delivery location for each order included in a batch 500 of new or existing orders, or any other suitable types of information. For example, based on a timeline for the batch 500 of existing orders being serviced by the picker 510 determined by the online concierge system 140, the online concierge system 140 may determine an amount of time that is likely to elapse before the picker 510 may begin to service a batch 500 of new orders. In this example, the online concierge system 140 also may determine amounts of time other pickers 510 are likely to take to accept batches 500 of new orders for servicing (e.g., based on picker data stored in the data store 240 describing an average amount of time that each picker 510 available to service orders takes to accept a batch 500 of new orders for servicing). Continuing with this example, the online concierge system 140 may compare the amount of time that is likely to elapse before the picker 510 servicing the batch 500 of existing orders may begin to service a batch 500 of new orders with the amounts of time that other pickers 510 are likely to take to accept batches 500 of new orders for servicing and match (step 330) batches 500 of new orders with pickers 510 based on the comparison. In the above example, the online concierge system 140 also may take into account a delivery timeframe and a delivery location for each new order included in each batch 500 of new orders, such that each batch 500 may be matched 330 with one or more pickers 510 in a way that minimizes the likelihood that the new order(s) will be delivered late.

The online concierge system 140 may match 330 the picker 510 servicing the batch 500 of existing orders with up to a maximum number of batches 500 of new orders. The maximum number of batches 500 of new orders may be determined (e.g., using the matching module 225) based on one or more attributes of the picker 510, one or more attributes of each batch 500 of new orders, the current marketplace state, timeframes within which other pickers 510 are willing to service orders, or any other suitable types of information. For example, the online concierge system 140 may determine a maximum number of batches 500 of new orders that may be matched 330 with the picker 510 based on an average number of hours the picker 510 services orders per day, a number of hours the picker 510 has serviced orders so far that day, an average amount of earnings for the picker 510 per day, and an amount of earnings for the picker 510 so far that day. In this example, the maximum number of batches 500 of new orders that may be matched 330 with the picker 510 may be inversely proportional to a ratio of the number of hours the picker 510 has serviced orders so far that day to the average number of hours the picker 510 services orders per day or to a ratio of the amount of earnings for the picker 510 so far that day to the average amount of earnings for the picker 510 per day. In the above example, the maximum number of batches 500 also may be inversely proportional to a number of additional pickers 510 available to service orders, a number of items included in each batch 500 of new orders, etc.

Referring again to FIG. 3, the online concierge system 140 determines 335 (e.g., using the request module 226) whether one or more batches 500 of new orders have been matched 330 with the picker 510 servicing the batch 500 of existing orders and generates (e.g., using the request module 226) one or more requests to service the batch(es) 500 based on the determination. The online concierge system 140 may generate a request to service a batch 500 of new orders upon determining 335 that the batch 500 has been matched 330 with the picker 510. A request to service a batch 500 of new orders may include various types of information associated with the batch 500. For example, a request to service a batch 500 of new orders may include various types of information associated with each new order included in the batch 500, such as a delivery location associated with each new order, information describing one or more items included in each new order, an amount of pay associated with each new order, a delivery timeframe for each new order, etc. A request to service a batch 500 of new orders also may include one or more interactive elements (e.g., buttons) that allow the picker 510 to accept or reject the batch 500 for servicing. If the online concierge system 140 determines 335 that none of the batches 500 of new orders have been matched 330 with the picker 510 servicing the batch 500 of existing orders, one or more of the steps described above may be repeated (e.g., by proceeding back to step 305).

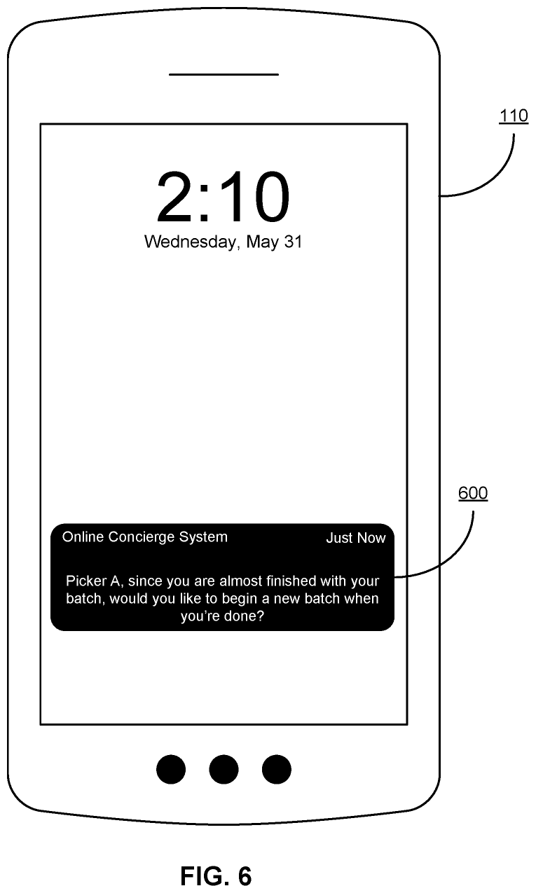

Once the request(s) to service the batch(es) 500 of new orders have been generated, the online concierge system 140 may send 340 (e.g., via the interface module 227) the request(s) for display to the picker client device 110 associated with the picker 510 (e.g., as a push notification, as a text message, etc.). The picker 510 may then accept the batch(es) 500 for servicing. FIG. 6 illustrates an example of a request 600 to service a batch 500 of new orders sent 340 to a picker client device 110 associated with a picker 510 servicing a batch 500 of existing orders, in accordance with one or more embodiments. As shown in FIG. 6, a request 600 to service a batch 500 of new orders may be sent 340 to the picker client device 110 associated with the picker 510 as a push notification. In this example, upon clicking on the notification, the picker 510 may be presented with details about the batch 500 and options to accept or decline the batch 500 for servicing. If the picker 510 accepts a batch 500 of new orders for servicing while servicing the batch 500 of existing orders, the picker 510 may begin servicing the batch 500 of new orders once they have finished servicing the batch 500 of existing orders.

Referring once more to FIG. 3, in some embodiments, even if the online concierge system 140 has matched 330 a batch 500 of new orders with the picker 510 and generates a request 600 to service the batch 500, the online concierge system 140 determines (e.g., using the interface module 227) whether to send 340 the request 600 for display to the picker client device 110 associated with the picker 510. In such embodiments, the online concierge system 140 may or may not send 340 the request 600 based on the determination. The online concierge system 140 may make this determination based on a number of requests 600 to service batches 500 of new orders sent 340 to the picker client device 110 (e.g., within a timespan), a frequency with which requests 600 to service batches 500 of new orders are being sent 340 to the picker client device 110, or any other suitable types of information. For example, suppose that a constraint limits a number of requests 600 to service batches 500 of new orders that may be sent 340 to pickers 510 servicing batches 500 of existing orders to 15 requests 600 within the same hour. In this example, the online concierge system 140 may determine that a request 600 to service a batch 500 of new orders should not be sent 340 to the picker client device 110 associated with the picker 510 servicing the batch 500 of existing orders if 15 requests 600 to service batches 500 of new orders have already been sent 340 to the picker client device 110 within the last hour. The online concierge system 140 may send 340 a request 600 to service a batch 500 of new orders to the picker client device 110 associated with the picker 510 upon determining that the request 600 may be sent 340. If the online concierge system 140 determines that the request 600 to service the batch 500 of new orders should not be sent 340 to the picker client device 110, the online concierge system 140 may then match 330 the batch 500 of new orders associated with the request 600 with a different picker 510. Similarly, if the online concierge system 140 sends 340 the request 600 to service the batch 500 of new orders to the picker client device 110, but the picker 510 declines the request 600 or does not accept it within a threshold amount of time, the online concierge system 140 may match 330 the batch 500 of new orders associated with the request 600 with a different picker 510.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
receiving, at an online concierge system, information describing a progress of a picker servicing a set of existing orders;
predicting a first likelihood that the picker will finish servicing the set of existing orders within a threshold amount of time, wherein predicting the first likelihood is based at least in part on the progress of the picker and information describing the set of existing orders;
determining whether the first likelihood exceeds a threshold likelihood;
responsive to determining the first likelihood exceeds the threshold likelihood, accessing a machine learning model trained to predict a second likelihood that the picker will accept a set of new orders for servicing while servicing the set of existing orders, wherein the machine learning model is trained by:
receiving historical data describing acceptance, by pickers, of requests to service sets of new orders while servicing sets of existing orders, and
training the machine learning model based at least in part on the historical data;
applying the machine learning model to a set of inputs to predict the second likelihood that the picker will accept the set of new orders for servicing while servicing the set of existing orders, wherein the set of inputs comprises a set of attributes of the picker and the progress of the picker;
matching a plurality of sets of new orders with a plurality of pickers based at least in part on the second likelihood;
determining whether one or more sets of new orders are matched with the picker; and
responsive to determining the one or more sets of new orders are matched with the picker, sending one or more requests to service the one or more sets of new orders to a client device associated with the picker.

2. The method of claim 1, further comprising:
accessing an additional machine learning model trained to predict the first likelihood that the picker will finish servicing the set of existing orders within the threshold amount of time, wherein the additional machine learning model is trained by:
receiving historical order data describing orders serviced by pickers of the online concierge system and amounts of time required to service the orders, and
training the machine learning model based at least in part on the historical order data;
identifying a set of order attributes of each existing order of the set of existing orders; and
applying the additional machine learning model to the progress of the picker and the set of order attributes to predict the first likelihood that the picker will finish servicing the set of existing orders within the threshold amount of time.

3. The method of claim 2, wherein the set of order attributes comprises one or more of: a number of items included in each existing order of the set of existing orders, a size of each item included in each existing order of the set of existing orders, a retailer location from which items included in each existing order of the set of existing orders is to be collected, a delivery location for each existing order of the set of existing orders, or a delivery timeframe for each existing order of the set of existing orders.

4. The method of claim 1, further comprising:
determining the threshold amount of time based at least in part on an amount of time that each picker of the plurality of pickers is predicted to take to accept a set of orders for servicing.

5. The method of claim 1, wherein applying the machine learning model to the set of attributes of the picker comprises applying the machine learning model to a number of hours worked by the picker during a time period and an average number of hours the picker works during the time period.

6. The method of claim 1, wherein applying the machine learning model to the set of attributes of the picker comprises applying the machine learning model to an amount of earnings for the picker during a time period and an average amount of earnings for the picker during the time period.

7. The method of claim 1, wherein receiving the information describing the progress of the picker servicing the set of existing orders comprises receiving: a number of the set of existing orders that have not been delivered, a location associated with the picker, a number of items included in the set of existing orders that have not been collected, or a state associated with the picker.

8. The method of claim 7, wherein receiving the state associated with the picker comprises receiving an indication that the picker is performing one or more of: driving, collecting items, checking out, or arriving.

9. The method of claim 1, wherein matching the plurality of sets of new orders with the plurality of pickers is further based at least in part on an amount of time that each picker of the plurality of pickers is predicted to take to accept a set of new orders for servicing and an amount of time until the picker is likely to finish servicing the set of existing orders.

10. The method of claim 1, wherein a number of the one or more sets of new orders matched with the picker is less than a maximum number and the maximum number is determined based at least in part on the set of attributes of the picker and one or more of: a number of the plurality of pickers, a current marketplace state, or a set of order attributes of each new order of the one or more sets of new orders.

11. A computer program product comprising a non-transitory computer-readable storage medium having instructions encoded thereon that, when executed by a processor, cause the processor to perform steps comprising:
receiving, at an online concierge system, information describing a progress of a picker servicing a set of existing orders;
predicting a first likelihood that the picker will finish servicing the set of existing orders within a threshold amount of time, wherein predicting the first likelihood is based at least in part on the progress of the picker and information describing the set of existing orders;
determining whether the first likelihood exceeds a threshold likelihood;
responsive to determining the first likelihood exceeds the threshold likelihood, accessing a machine learning model trained to predict a second likelihood that the picker will accept a set of new orders for servicing while servicing the set of existing orders, wherein the machine learning model is trained by:
receiving historical data describing acceptance, by pickers, of requests to service sets of new orders while servicing sets of existing orders, and
training the machine learning model based at least in part on the historical data;
applying the machine learning model to a set of inputs to predict the second likelihood that the picker will accept the set of new orders for servicing while servicing the set of existing orders, wherein the set of inputs comprises a set of attributes of the picker and the progress of the picker;
matching a plurality of sets of new orders with a plurality of pickers based at least in part on the second likelihood;
determining whether one or more sets of new orders are matched with the picker; and
responsive to determining the one or more sets of new orders are matched with the picker, sending one or more requests to service the one or more sets of new orders to a client device associated with the picker.

12. The computer program product of claim 11, wherein the non-transitory computer-readable storage medium further has instructions encoded thereon that, when executed by the processor, cause the processor to perform steps comprising:
accessing an additional machine learning model trained to predict the first likelihood that the picker will finish servicing the set of existing orders within the threshold amount of time, wherein the additional machine learning model is trained by:
receiving historical order data describing orders serviced by pickers of the online concierge system and amounts of time required to service the orders, and
training the machine learning model based at least in part on the historical order data;
identifying a set of order attributes of each existing order of the set of existing orders; and
applying the additional machine learning model to the progress of the picker and the set of order attributes to predict the first likelihood that the picker will finish servicing the set of existing orders within the threshold amount of time.

13. The computer program product of claim 12, wherein the set of order attributes comprises one or more of: a number of items included in each existing order of the set of existing orders, a size of each item included in each existing order of the set of existing orders, a retailer location from which items included in each existing order of the set of existing orders is to be collected, a delivery location for each existing order of the set of existing orders, or a delivery timeframe for each existing order of the set of existing orders.

14. The computer program product of claim 11, wherein the non-transitory computer-readable storage medium further has instructions encoded thereon that, when executed by the processor, cause the processor to perform steps comprising:
determining the threshold amount of time based at least in part on an amount of time that each picker of the plurality of pickers is predicted to take to accept a set of orders for servicing.

15. The computer program product of claim 11, wherein applying the machine learning model to the set of attributes of the picker comprises applying the machine learning model to a number of hours worked by the picker during a time period and an average number of hours the picker works during the time period.

16. The computer program product of claim 11, wherein applying the machine learning model to the set of attributes of the picker comprises applying the machine learning model to an amount of earnings for the picker during a time period and an average amount of earnings for the picker during the time period.

17. The computer program product of claim 11, wherein receiving the information describing the progress of the picker servicing the set of existing orders comprises receiving: a number of the set of existing orders that have not been delivered, a location associated with the picker, a number of items included in the set of existing orders that have not been collected, or a state associated with the picker.

18. The computer program product of claim 17, wherein receiving the state associated with the picker comprises receiving an indication that the picker is performing one or more of:
driving, collecting items, checking out, or arriving.

19. The computer program product of claim 11, wherein match the plurality of sets of new orders with the plurality of pickers is further based at least in part on an amount of time that each picker of the plurality of pickers is predicted to take to accept a set of new orders for servicing and an amount of time until the picker is likely to finish servicing the set of existing orders.

20. A computer system comprising:
a processor; and
a non-transitory computer-readable storage medium storing instructions that, when executed by the processor, perform actions comprising:
receiving, at an online concierge system, information describing a progress of a picker servicing a set of existing orders;
predicting a first likelihood that the picker will finish servicing the set of existing orders within a threshold amount of time, wherein predicting the first likelihood is based at least in part on the progress of the picker and information describing the set of existing orders;
determining whether the first likelihood exceeds a threshold likelihood;
responsive to determining the first likelihood exceeds the threshold likelihood, accessing a machine learning model trained to predict a second likelihood that the picker will accept a set of new orders for servicing while servicing the set of existing orders, wherein the machine learning model is trained by:
receiving historical data describing acceptance, by pickers, of requests to service sets of new orders while servicing sets of existing orders, and
training the machine learning model based at least in part on the historical data;
applying the machine learning model to a set of inputs to predict the second likelihood that the picker will accept the set of new orders for servicing while servicing the set of existing orders, wherein the set of inputs comprises a set of attributes of the picker and the progress of the picker;
matching a plurality of sets of new orders with a plurality of pickers based at least in part on the second likelihood;
determining whether one or more sets of new orders are matched with the picker; and
responsive to determining the one or more sets of new orders are matched with the picker, sending one or more requests to service the one or more sets of new orders to a client device associated with the picker.
